(19) United States
(12) Patent Application Publication
(10) Pub. No.: US 2014/0136322 A1
(43) Pub. Date: May 15, 2014

(54) SYSTEM TO CROSS INCENTIVIZE FOOD AND ENTERTAINMENT SALES

(71) Applicant: Gordon Ray Morehead, Colorado Springs, CO (US)

(72) Inventor: Gordon Ray Morehead, Colorado Springs, CO (US)

(21) Appl. No.: 13/677,958

(22) Filed: Nov. 15, 2012

(51) Int. Cl. G06Q 30/02

(52) U.S. Cl. CPC G06Q 30/0255; G06Q 30/0273
USPC 705/14.53

(57) ABSTRACT

Methods and systems for the cross incentivizing of food and entertainment sales. In one aspect, a method includes receiving an entertainment selection from a user. In response to the received entertainment selection, presenting to the user information concerning at least one sponsoring food, wherein a sponsoring food when selected covers a cost of the selected entertainment. Then receiving from the user a sponsoring food selection and retrieving the selected entertainment from a location differing from the location of where the selected sponsoring food is prepared. Afterwards, delivering the selected entertainment and the selected sponsoring food to the user.

### BACKGROUND

This specification relates to the facilitation of sales of food and entertainment utilizing cross sale encouragement and enhancement.

Foods may differ and what's considered entertainment likewise varies as you travel around the world. What doesn't change as you travel around the world is that food is intimately linked with entertainment. Advertisers, merchants, and even regular people recognize and try to utilize and benefit from the pairing of food and entertainment. For example, advertisers focus and channel advertisements around meals and meal times.

However, achieving the pairing of a desired entertainment with a desired food is not always easy in today's society. For example, the average person faces great demands upon his time. As such, the average person may not have the time to successfully procure his desired food and desired entertainment. Or, the time taken may be such that his desired food and/or entertainment is no longer appealing by the time he successfully procures his desired food and the desired entertainment. Additionally, the average person has no guarantee that his efforts in procuring his desired food and desired entertainment will be successful.

Likewise, successfully incentivizing a food, an entertainment, or a mechanism with which to procure food or entertainment can also be difficult for an advertiser. Most advertisements and incentive efforts are ignored. The average person encounters hundreds if not thousands of different advertisements every day. As such, it is actually difficult to provide meaningful incentives for purchasing a food or entertainment or to perform that purchase through a specific mechanism. Thus, there is a need for a means and a method for improved pairing of food and entertainment, the improved delivery of the food and entertainment and the improved incentivizing of a food with an entertainment and the mechanisms for the delivery for said food and entertainment.

### SUMMARY

This specification describes technologies relating to cross incentivization of food and entertainment purchases.

In general, one innovative aspect of the present novel technology relates to the incentivizing of food purchases during a consumer's acquisition and/or purchase of entertainment. Another innovative aspect of the subject matter described in this specification relates to the incentivizing of entertainment purchases during a consumer's purchase of food. Yet another innovative aspect of the subject matter described in this specification relates to the incentivizing of specific mechanisms for the delivery of food and/or entertainment. Another innovative aspect of the subject matter described in this specification relates to the enhancement of the mechanism with which a consumer's purchase of food and/or entertainment is performed. Yet another innovative aspect of the subject matter described in this specification relates to incentivizing of joint food and entertainment purchases where the joint purchase uses a single transaction and the joint purchases of food and entertainment potentially use a common means of delivery.

Particular embodiments of the subject matter described in this specification can be implemented so as to realize one or more of the following advantages. Advertisements for food or entertainment are presented to consumers at times likely to enhance the effectiveness of said advertisements. Consumer resistance to food or entertainment delivery mechanisms is decreased, likely enhancing a consumer's first time use of an unfamiliar delivery mechanism or purchase of an unfamiliar food or entertainment. A consumer's first or possibly subsequent use of a mechanism for food or entertainment delivery can be partially subsidized yielding, among other benefits, a larger consumer pool.

The details of one or more embodiments of the subject matter described in this specification are set forth in the accompanying descriptions below. Other features, aspects, and advantages of the subject matter will become apparent from the descriptions and the claims.

### BRIEF DESCRIPTION OF THE DRAWINGS

FIG. 1 is a block diagram of an example environment in which a system to cross incentivize food and entertainment purchases functions.

FIG. 2 is a block diagram of an example process flow of a system to cross incentivize food and entertainment sales.

FIG. 3 is a diagram of an example process flow of a system to cross incentivize food and entertainment sales from the view of a consumer wishing to rent a movie from a movie kiosk.

FIG. 4 is block diagram of an example computer system that can be used to implement a system to cross incentivize food and entertainment sales.

Like reference numbers and designations in the various drawings indicate like elements.

### DETAILED DESCRIPTION

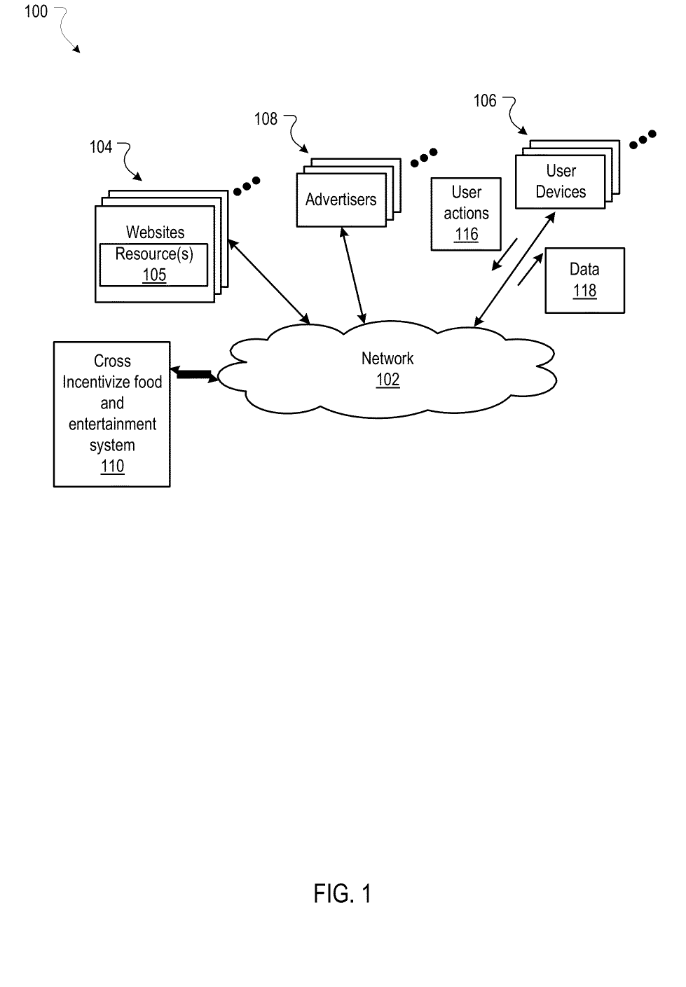

FIG. 1 is a block diagram 100 of an example environment in which a system to cross incentivize food and entertainment purchases 110 functions. The following is a description of how an example environment in a system to cross incentivize food and entertainment sales 110 can be used. For example, the environment includes a system to cross incentivize food and entertainment sales 110 that provides incentives to consumers and/or users for the purchase of food and/or entertainment as well as providing other services such as tracking and processing sale and/or consumer information, providing delivery mechanism enhancements and/or incentives for said delivery mechanisms, and the like. The example environment also includes a network 102, such as a local area network (LAN), a wide area network (WAN), the Internet, a game network, a communication network, a proprietary network, or a combination thereof. The network connects websites 104, resources 105, user and/or consumer devices 106, and the system to cross incentivize food and entertainment sales 110. The example environment may include many thousands of websites and user and/or consumer devices.

A website 104 is one or more resources 105 associated with a domain name and hosted by one or more servers. An example website 104 is a collection of web pages formatted in hypertext markup language (HTML) that can contain text, images, multimedia content, and programming elements, such as scripts. Each website is maintained by a publisher, which is an entity that controls, manages and/or owns the website.

A resource 105 is any data that can be provided over the network. In some examples, a resource is identified by a resource address (URL) that is associated with the resource 105. However, a resource may also be addressed by other means such as the resource 105 being associated with a unique IP address, telephone number, or the like. Example resources 105 include HTML pages, word processing documents, and portable document format (PDF) documents, images, video, text, audio, and feed sources, and the like. The resources 105 can include content, such as location data, entertainment data, food data, advertisement information and the like. For example, the resources 105 can include advertisement information, words, phrases, images and sounds, that may include embedded information (such as meta-information in hyperlinks) and/or embedded instructions (such as JavaScript scripts). Such information can serve to detail a mechanism of delivery of food or entertainment, a description of an advertised food or entertainment, the reviews of said advertised food or entertainment, and the like.

A user device 106 is an electronic device that is under control of a user and is capable of sending the user actions 116 and or user data to, and receiving data 118 from the system to cross incentivize food and entertainment sales 110. In one example, a user action is a user instruction causing the system to cross incentivize food and entertainment sales 110 to perform some action. For example, a user instruction could be the user's purchase of a specific advertised food or entertainment.

Data 118 is information that the user device receives. For example, data 118 may be an advertisement for the offering of a free delivery of a movie rental with the purchase of a delivered pizza. In some implementations, the user device 106 is also capable of requesting and receiving resources 105 over the network. Example user devices 106 include personal computers, mobile communication devices, game systems, and other devices that can send user actions 116 and user data and receive data 118 over the network. In one example, a user device 106 includes a user application to facilitate the user actions 116, manage user data and data over the network. Some user devices may also possess the ability to derive information independently of the user and to distribute that information. For example, a user's smart phone could be equipped with an application capable of sending user actions 116 for the selection of the free movie rental delivered free with a purchase of a delivered pizza and producing a visual representation of the data 118 received that confirms the user's purchase of the delivered pizza and movie. The same smart phone could also possess global positioning capability and automatically send the user's location as part of the pizza and movie purchase transaction.

The system to cross incentivize food and entertainment sales 110 provides a means by which advertisers 108 and merchants can cross incentivize their products through the use of natural pairings of the products, presentations of advertisements for products in paired settings, and enhancements of the mechanisms used for delivery of the products. The system 110 also enables additional benefits to be conveyed to the users/consumers such as free trial of entertainment delivery mechanisms, subsidizing of food purchases, tracking of consumer behavior, prediction of desirable products, and the like. In some implementations, users can also opt to provide additional information that may be used to enhance the likelihood of user satisfaction with purchased food and/or entertainment. In some implementations, the user can opt to provide such additional information through automatic means. For example, a user may allow the use of an application upon the user's smart phone that relays the user's positional information to the system to cross incentivize food and entertainment sales 110. The user's positional information can then be used to enable the delivery of the user's selected food and entertainment when the user reaches his destination.

Additionally, updates concerning the delivery of the user's purchased food and entertainment could be sent to the user. For example, the user could receive email updates, data updates causing a smart phone application to inform the user of the purchase's location, and the like.

The system to cross incentivize food and entertainment sales 110 also provides a means by which advertisements can be adapted and displayed to users in a way and location such that a cross sale is incentivized. As an example, the system to cross incentivize food and entertainment sales can provide advertisements to kiosk movies rental devices for cross incentivizing a pizza sale. In such an example, the kiosk movies rental device could, in response to a user's selection of a movie, display an advertisement to the consumer for the purchase of a delivery pizza. Since the consumer is already actively engaged in purchasing/renting a movie, the consumer is more likely to purchase food as well. Thus, the presenting the consumer with an ad for the purchase of a delivered pizza at the time of the consumer selecting a movie to rent is more likely to result in a cross incentivized sale of the pizza. Additionally, as an added incentive, the system to cross incentivize food and entertainment sales 110 enables the advertisers to subsidize one or more of the consumer's purchases. In this example, the pizza vendor could pay for the consumer's movie rental in the event that the consumer agrees to purchase the delivered pizza. In some implementations, the system to cross incentivize food and entertainment sales 110 also tracks the sales information, receives payment (which are in the form of a credit transaction in some examples), and places an order for the cross sold good. In this example, the system to cross incentivize food and entertainment sales 110 would receive information permitting it to place and complete a transaction for the delivery of a pizza to the purchasing consumer. Note, while the example presented an incentivized pizza sale, the incentivized sale can be virtually any product or service that is beneficially advertised during the selection of another good or service.

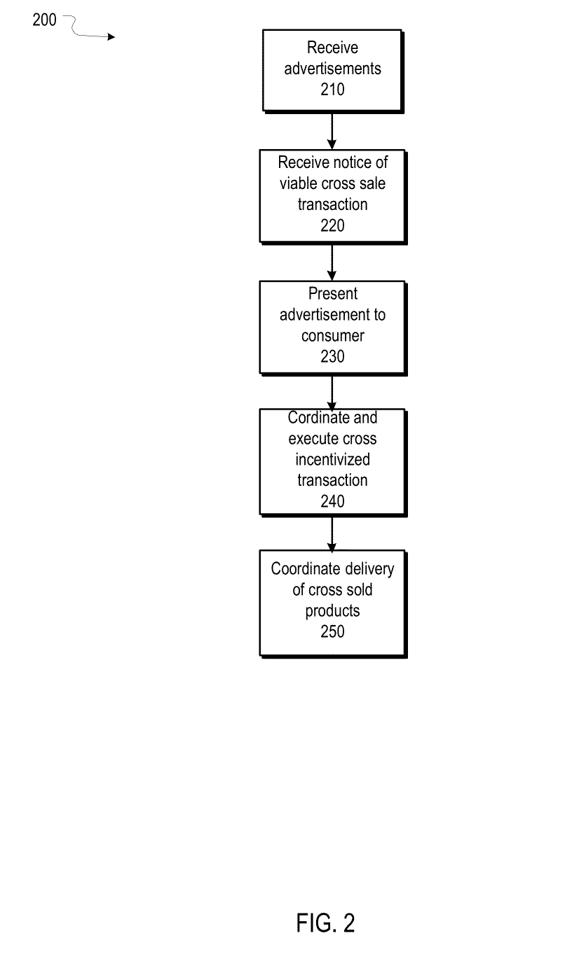

FIG. 2 is a block diagram 200 of an example process flow of a system to cross incentivize food and entertainment sales 110. The system receives advertisements (210) for presentation to consumers in cross sale situations. A cross sale situation is a situation where a consumer is engaged in a transaction concerning a subject that naturally lends itself to pairing with a subsequent good or service. An example of a cross sale situation is a consumer's purchase of entertainment. Since food is a natural pairing with entertainment, a consumer purchasing entertainment is more likely to engage in a cross sale to subsequently purchase food. The advertisements include various information such as the preferred pairings (preferred association to the cross sale good), dates of validity, terms of the advertisement, benefit of the advertisement, terms of the additional incentive (if any), and the like.

In some implementations, the advertisements are received in a format enabling the system to cross incentivize food and entertainment sales 110 to readily adapt the advertisements for presentation upon websites 104, resources 105, user devices 106, and the like. For example, an advertisement can be received in a format enabling the system to cross incentivize food and entertainment sales to adapt the advertisement for presentation upon a kiosk movies rental device, a website 104, a smart phone, and the like.

The system to cross incentivize food and entertainment sales receives notice of a consumer engaging in a transaction viable for a cross sale (220). In some implementations, notice can be received from a website 104 intended for such cross sales. Alternatively, in some systems the notice can be received from websites 104, smart phone apps, control interfaces such as present upon kiosk movie rental boxes, voice and or tone based systems such as found within phone systems, and other such systems not specifically intended for cross sales but capable of receiving advertisements from the system 110 to cross incentivize food and entertainment sales. For example, the system to cross incentivize food and entertainment sales 110 receives notice that a consumer is in the process of renting a DVD from a movie kiosk.

The system to cross incentivize food and entertainment sales presents an advertisement to the consumer (230). The advertisement presented is based upon the consumer's transaction. For example, if the consumer is engaged in ordering a pizza, the advertisement can be for a free rental of a DVD. In some implementations, the system permits the advertiser to sponsor the original transaction in the event that the consumer accepts the cross sale. In the case of the consumer ordering a pizza, the consumer could be presented with a deal where the pizza was reduced in price or even free.

In some implementations, the system to cross incentivize food and entertainment sales coordinates and executes the cross incentivized transaction (240). Additionally, some implementations coordinate and execute both the originating transaction and the cross incentivized transaction. Furthermore, some implementations also target specific consumers for certain cross sale opportunities. In some examples, such targeting of consumers is performed on consumers that have given their permission to participate in such direct marketing. Often the participation is rewarded with additional deals or discounts for the cross incentivized products and services. For example, the system to cross incentivize food and entertainment sales can target those consumers who have opted to download an application to their smart phone. Periodically, the application can notify the consumers of new or specific cross incentivized deals that they may desire to participate in.

Continuing the example, when the consumer participates in such deals, the system to cross incentivize food and entertainment sales receives all the necessary information such as billing information, desired delivery location, delivery time, and the like and then coordinates with the advertisers to have the cross incentivized products delivered. In some implementations, the coordination can include ordering the products, scheduling the delivery, paying the advertisers, mapping the delivery routes, and receiving customer feedback.

Furthermore, in some implementations the system to cross incentivize food and entertainment sales can also coordinate the delivery of the cross sold products (250) with the occurrence of a consumer designated event such as the consumer arriving home. In some examples, such coordination makes use of smart phone. However, other means of notifying the system to cross incentivize food and entertainment sales of event are possible and include such examples as the consumer logging into a website to disclose the occurrence of the vent, placing a call to the system to cross incentivize food and entertainment sales, the consumer sending an email notifying of the occurrence of the event, and the like. As an example, the system to cross incentivize food and entertainment sales 110 could periodically query a consumer's smart phone as to the location of consumer. In this way, the system to cross incentivize food and entertainment sales 110 could ensure that the consumer's selected movie and pizza was delivered a set time after the consumer arrives home.

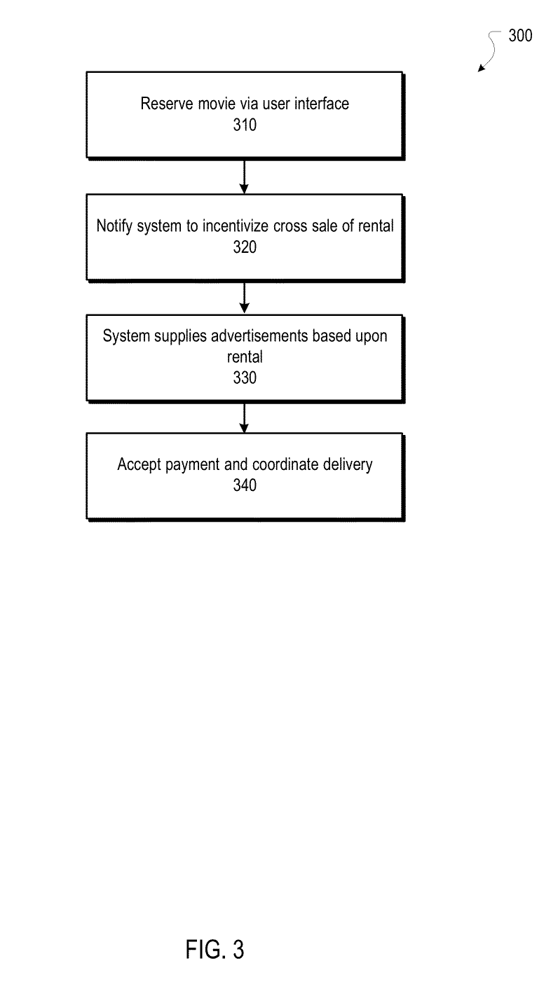

FIG. 3 is a diagram 300 of an example process flow of a system to cross incentivize food and entertainment sales 110 from the view of a consumer wishing to rent a movie from a movie kiosk. The consumer reserves the movie at movie rental kiosk website via a user interface (310). Without effort on the part of the consumer, the movie rental kiosk website notifies the system to cross incentivize food and entertainment sales of the rental (320). The system to cross incentivize food and entertainment sales supplies the movie rental kiosk website with advertisements based upon the desired rental (330). For example, the advertisements feature deals for purchasing delivered pizza. As an added incentive, the purchase of a pizza could make the movie rental free.

If accepted, the system to cross incentivize food and entertainment sales accepts payment and coordinates (340) the delivery of the pizza and the movie. In some examples, the system imposes a fee for the joint purchase of food and entertainment, the fee being invisible to the purchaser and being deducted from the purchase total before the purchase total is divided and distributed respectively to the purveyors of the food and entertainment. Coordination includes the scheduling of the delivery of the pizza, planning the route of the delivery such that the delivery person can also pick up the consumer's desired movie, and distribution of payment for the pizza and movie. Note that the coordination may include planning the route of delivery such that the route is likely to result in a speedy delivery of the food and entertainment. Also, the route can be such that additional efficiencies such as conservation of fuel and the like can be gained through the common delivery of the food and entertainment.

In some implementations, the system to cross incentivize food and entertainment sales can accept vendor codes, promotion codes, advertiser codes, and the like from users. The vendor codes, promotion codes, advertiser codes, and the like enable merchants to tie in existing advertising and promotions. For example, a user could enter in, as part of the user's transaction, a promotion code obtained from a merchant's advertisement that enables the user to a discount on his purchase total.

In the case where the pizza purchase also covers the cost of the movie, the system to cross incentivize food and entertainment sales also debits the corresponding pizza purveyor accordingly. In some implementations, this payment can be accomplished at a discount or through payment arrangement previously agreed to. For example, the movie rental kiosk owner can previously agree to pay a set fee to the pizza merchant or a delivery service for the delivery of the movie. In one example, the kiosk owner would also negotiate with the pizza purveyor for a referral commission, and to possibly supply an inventory of the most popular movies at the pizza location.

When the pizza is ready, the driver is given delivery instructions including not only the address of the consumer but also the location from which to obtain the movie from. In some implementations, the directions include a code for the driver to use to obtain the movie from the movie rental kiosk. Furthermore, some implementations can also interrogate the movie rental kiosks along the delivery route to ensure that the movie rental kiosk has the desired movie available.

It should be noted that while this example makes use of a movie rental kiosk, the system to cross incentivize food and entertainment sales can be used with other means of entertainment distribution. As an example, the system to cross incentivize food and entertainment sales can be used with internet based entertainment distribution methods. Optionally as part of the consumer's transactions, the system to cross incentivize food and entertainment sales provides the consumer with a code the consumer can enter into an internet enabled device such as a computer or a smart phone or the like. The code permits the internet enabled device to temporarily be able to access an internet based entertainment delivery provide from which the consumer can download or stream his entertainment from.

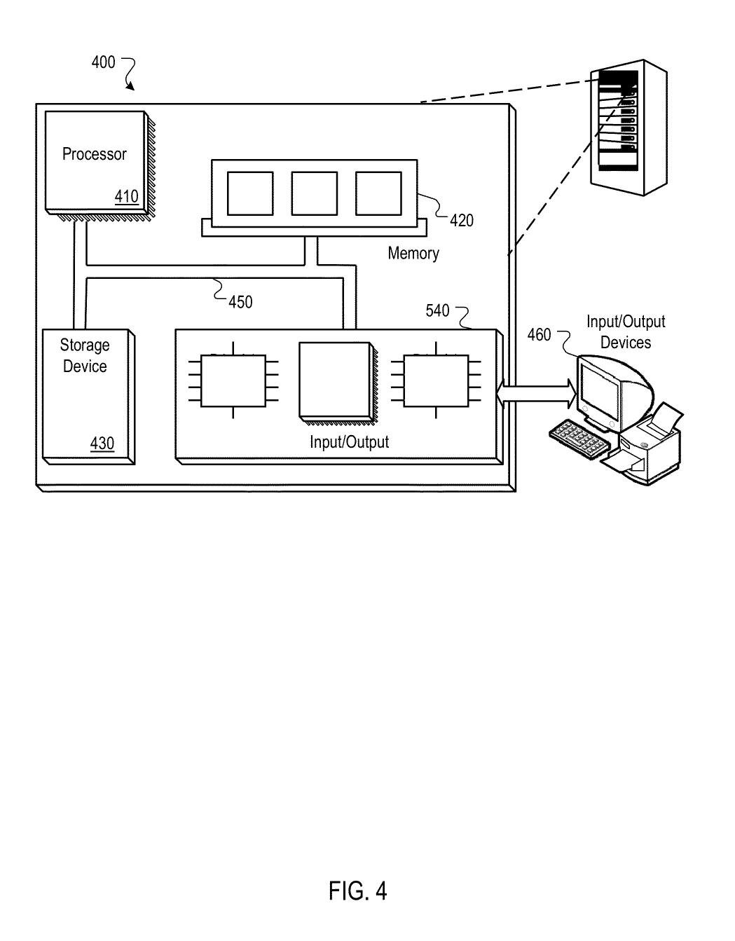

FIG. 4 is block diagram of an example computer system 400 that can be used to implement a system to cross incentivize food and entertainment sales 110. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 530.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As an example one such type of a computer, consider a type of computer system consisting of a programmable processing system (system) suitable for implementing apparatus or performing methods of various aspects of the subject matter described in this specification. The system includes a processor, a random access memory (RAM), a program memory (for example, a writable read-only memory (ROM) such as a flash ROM), a hard drive controller, a video controller, and an input/output (I/O) controller coupled by a processor (CPU) bus. The system can be preprogrammed, in ROM, for example, or it can be programmed (and reprogrammed) by loading a program from another source (for example, from a floppy disk, a CD-ROM, or another computer).

The hard drive controller is coupled to a hard disk suitable for storing executable computer programs, including programs embodying aspects of the subject matter described in this specification.

The video controller is coupled to a video recorder, which can be used for storing and importing video footage and for writing final output.

The I/O controller is coupled by means of an I/O bus to an I/O interface. The I/O interface receives and transmits data (e.g., stills, pictures, movies, and animations for importing into a composition) in analog or digital form over communication links such as a serial link, local area network, wireless link, and parallel link.

Also coupled to the I/O bus is a display and a keyboard. Alternatively, separate connections (separate buses) can be used for the I/O interface, display and keyboard.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for incentivizing delivered food sales, where the method comprises:
receiving an entertainment selection from a user;
presenting to the user information concerning at least one sponsoring food, wherein a sponsoring food when selected covers a cost of the selected entertainment;
receiving from the user a sponsoring food selection;
retrieving the selected entertainment, the selected entertainment retrieved from a location differing from the location of where the selected sponsoring food is prepared;
delivering the selected entertainment and the selected sponsoring food to the user.

2. The method of claim 1 wherein retrieving the selected entertainment further comprises:
deriving a selected entertainment retrieval path, the selected entertainment retrieval path optimized for delivery of the selected entertainment to the user.

3. The method of claim 1 further comprising a selected sponsoring food purveyor paying a fee to a selected entertainment purveyor.

4. The method of claim 1 further comprising a selected entertainment purveyor paying a fee to a selected sponsoring food purveyor.

5. The method of claim 1 wherein delivering the selected entertainment and the selected sponsoring food to the user occurs within a pre-designated time frame after the user arrives at a destination.

6. The method of claim 1 wherein the selected entertainment is delivered stored upon a physical medium.

7. The method of claim 1 wherein presenting to the user information concerning at least one sponsoring food further comprises forming a list of possible sponsoring foods based upon a user's past sponsoring food selections.

8. The method of claim 1 further comprising:
retrieving a user's history of entertainment selections;
analyzing the user's history of entertainment selections to determine a user's entertainment preferences;
sending an incentive to the user, the incentive based upon the user's entertainment preferences.

9. A method for timed delivery of incentivized delivered food, the method comprising:
providing to a user a list of incentivized delivered food, the incentivized delivered food incentivized through an accompanying entertainment offer;
receiving an incentivized delivered food selection from the user, wherein the incentivized delivered food selection includes a delivery time;
determining a delivery path, the delivery path based in part upon a location of a desired accompanying entertainment, and the delivery path ending at a location provided by the user;
retrieving the desired accompanying entertainment from a location on the delivery path;
delivering the incentivized delivered food at the location at a time based upon the delivery time.

10. The method of claim 9 wherein a location of a desired accompanying entertainment is determined by an availability of the desired accompanying entertainment.

11. The method of claim 9, wherein the delivery time is varies based upon a user's movements.

12. The method of claim 9 further comprising charging the user a single fee, the single fee accounting for the selected incentivized delivered food, the accompanying entertainment, and a delivery charge.

13. The method of claim 12, wherein a user's movements are tracked in near real time.

14. The method of claim 9 wherein the desired accompanying entertainment is delivered stored upon a physical medium.

15. The method of claim 9 wherein retrieving the desired accompanying entertainment from a location on the delivery path further comprises retrieving the desired accompanying entertainment from a kiosk.

16. The method of claim 9, wherein a list of incentivized delivered food is based in part upon a user's history of incentivized delivered food selections.
